(19) United States
(12) Patent Application Publication
(10) Pub. No.: US 2014/0195374 A1
(43) Pub. Date: Jul. 10, 2014

(54) MANAGING INVENTORY IN A SHOPPING STORE

(71) Applicant: International Business Machines Corporation, Armonk, NY (US)

(72) Inventors: Richard T. Bassemir, Austin, TX (US); Eric Forestier, Perols (FR); Alfredo V. Mendoza, Georgetown, TX (US); Didier Petitprez, Saint Jean de Vedas (FR); Andrew G. Tonkin, Morrisville, NC (US)

(73) Assignee: International Business Machines Corporation, Armonk, NY (US)

(21) Appl. No.: 14/066,825

(22) Filed: Oct. 30, 2013

Related U.S. Application Data
(63) Continuation of application No. 13/738,933, filed on Jan. 10, 2013.

(51) Int. Cl. G06Q 30/06; G06Q 10/08

(52) U.S. Cl. CPC G06Q 30/0639; G06Q 30/0633; G06Q 10/087
USPC 705/26.8

(57) ABSTRACT

A method for managing inventory includes detecting a shopping list on a communication device, transmitting the detected list to a server associated with the shopping store, transmitting images to the server, checking whether at least one item of the shopping list is present in an aisle based on a location of a consumer, scanning the images to identify images including the at least one item, and dynamically sorting the items in the shopping list based on the checking performed. The method also includes displaying the sorted list along with image links on the communication device, where at least one item in the sorted list is highlighted or placed on top based on the check performed, and where each of the image links includes an image with at least one augmented item. The method further includes determining items that need to be restocked in the shopping store.

### FIELD OF THE INVENTION

The present disclosure relates to computerized systems for obtaining item information and more specifically to systems and methods for providing shopping assistance to consumers and managing inventory in a shopping store.

### BACKGROUND

Typically, the shopping stores such as grocery stores provide multiple things of necessity to consumers under one roof in a convenient manner. But consumers often end up wasting a lot of time in searching for a particular item, as they might not be aware of item's exact location in the shopping store. For example, for a grocery store, the consumer usually have a long list of items, and for locating the items the consumers might have to walk up and down a store aisle's. This may be a tiring and challenging for the consumers. In addition, shopping stores usually stock a large variety of items and different stores may stock different combination of items in each of their aisles. Therefore, consumers may not be able to find every item of their shopping list on the first pass in the store and might have to backtrack to certain aisles.

Many shopping stores, grocery stores, or other large stores have developed systems to assist consumers by providing an listing products in the store alphabetically on signs suspended from the ceilings or printed listings on end of each aisle. Existing shopping list smartphone applications are mostly stand-alone applications that do not tell the consumer where a particular item is located within the store. A system is disclosed by Begum in a U.S. Pat. No. 6,177,880 for assisting consumers while locating items in a shopping store. The U.S. Pat. No. 6,177,880 discloses an electronic display incorporated into a shopping cart handle that allows a consumer to locate items by category or brand names. However, this system only provides aisle numbers and is limited to about 50 item categories. These days usually the shopping stores stocks thousands of item categories. In addition, the Begum invention inquiries are limited to a scrolling mechanism, since it lacks a means for alphanumerical entries. Further, the Begum invention is applicable only to a grocery store type layout consisting of aisles. The system disclosed in Begum's patent is ineffective if there are no aisle numbers.

Therefore, the consumer does not have an efficient way of finding items from the shopping list because the consumer might have to depend on the signs posted on each numbered aisle. These signs only provide a general list of items in the aisle and can be missed as the consumer walks through the main aisle. This results in the consumer doubling back several times if he/she misses an item from one aisle, which is inefficient.

In light of above discussion and limitations of existing techniques, there exists a need for systems and methods for assisting consumers in locating items in a shopping store in an effective manner.

### BRIEF SUMMARY

An embodiment of the present disclosure provides a method for managing inventory including a variety of items of a shopping store. The shopping store includes the variety of items arranged or placed in multiple shelves in multiple aisles. The method includes detecting, by a second communication device associated with an aisle, a shopping list comprising one or more items on a first communication device. A consumer inputs the list on the first communication device. The method also includes transmitting, by the second communication device, the detected list to a server associated with the shopping store. The method also includes transmitting, by a plurality of image capturing devices, a plurality of images to the server. The method also includes checking, by the server, at least one item of the received list is present in an aisle associated with the at least one second communication device from which the shopping list is received based on an identified location of the consumer. The method also includes scanning, by the server, the plurality of images to identify one or more images including the at least one item. The method further includes dynamically sorting, by the server, the one or more items in the received list based on the checking performed. The method also includes displaying the dynamically sorted list along with one or more image links on the first communication device, wherein the at least one item in the sorted list is at least one of highlighted or placed on top based on the check performed, further wherein each of the image links comprises an image with at least one augmented item. The method further includes determining, by the server. The one or more items need to be restocked in a plurality of shelves in the shopping store to maintain the inventory of the plurality of items based on the plurality of images.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 illustrates an exemplary environment where various embodiments of the present disclosure may function;

FIG. 2 illustrates an exemplary first communication device e.g. a smart phone including a shopping application, in accordance with an embodiment of the present disclosure;

FIG. 3 illustrates exemplary structural components of the server, in accordance with an embodiment of the present disclosure;

FIG. 4 is an exemplary environment illustrating the location of the one or more second communication devices and image capturing devices in a shopping store, in accordance with an embodiment of the present disclosure;

FIG. 5 illustrates communication between one or more devices in the shopping store, in accordance with an embodiment of the present disclosure;

FIG. 6 depicts before and after display of one or more items on the first communication device after the communication between the backend server and the shopping application, in accordance with an embodiment of the present disclosure;

FIG. 7 is an exemplary image, in accordance with an embodiment of the present disclosure;

FIG. 8 illustrates a flowchart diagram illustrating a method for intelligently locating one or more items in a shopping store, in accordance with an embodiment of the present disclosure; and

FIG. 9 illustrates a flowchart diagram illustrating a method for updating a database with a plurality of images by one or more image capturing devices, in accordance with an embodiment of the present disclosure.

### DETAILED DESCRIPTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wired, optical fiber cable, RF cable, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the consumer's computer, partly on the consumer's computer, as a stand-alone software package, partly on the consumer's computer and partly on a remote computer or entirely on the remote computer or server. In the latter scenario, the remote computer may be connected to the consumer's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions, which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

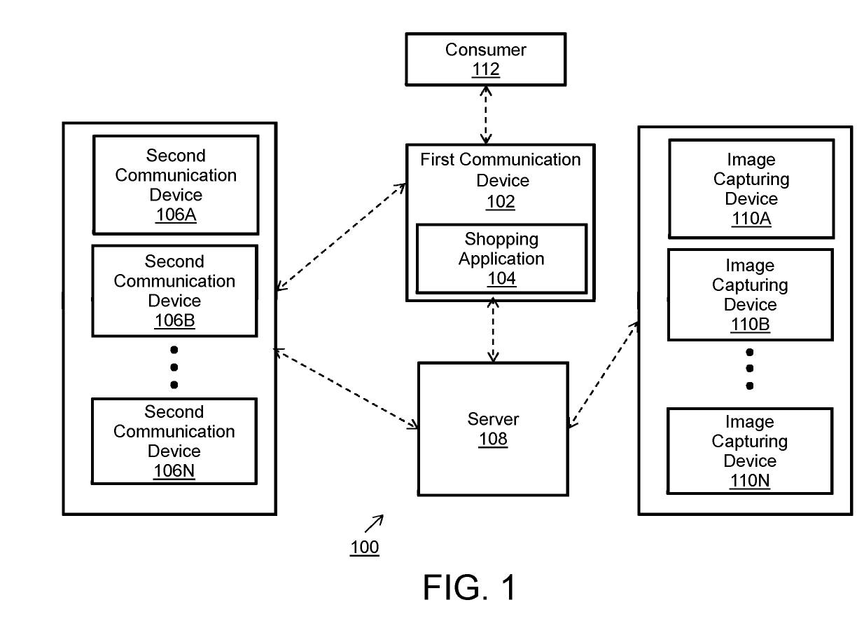

With reference now to the figures and in particular with reference to FIG. 1, exemplary diagram of an exemplary shopping store including a shopping assistance system is provided in which illustrative embodiments may be implemented. It should be appreciated that FIG. 1 is only exemplary and are not intended to assert or imply any limitation with regard to the environment in which different embodiments may be implemented. Many modifications to the depicted environment may be made.

FIG. 1 illustrates an exemplary shopping store 100 where various embodiments of the present disclosure may function. The shopping store 100 may include a shopping application 104 running on a first communication device 102. The first communication device 102 can be any portable communication device capable of communicating with other nearby communication devices. Examples of the first communication device 102 may include, but are not limited to, a cell phone, a smartphone, a personal digital assistant (PDA), a tablet computer, a laptop computer, and so forth. The shopping application 104 may allow a consumer 112 to enter a list of one or more items on the first communication device 102. The items can be commodities or products available in the shopping store 100. Further, the consumer 112 can be any person who enters the shopping store 100 for shopping etc. The consumer 112 may carry the first communication device 102 to the shopping store 100. The shopping application 104 can be hardware, software, firmware, or combination of these. Further, the shopping application 104 is configured to allow the consumer 112 to input a number of shopping lists associated with multiple different shopping stores. The shopping store 100 can be, an electronics store, a grocery store, a medical store, and so forth.

The shopping store 100 may further include a number of second communication devices 106A-N located or placed strategically in the shopping store 100. The shopping store 100 may be divided into a number of aisles. Further each of the aisles may include a number of shelves to store or place a number of products or items. The second communication devices 106A-N can be any suitable communication devices capable of communicating with the first communication device 102 and/or a server 108 via one or more wireless communication technologies or protocols such as, but are not limited to, Bluetooth, WAN 802.11, and so forth. Further, each of the second communication devices 106A-N is configured to detect the shopping list on the first communication device 102 when the consumer 112 is within a range of distance of the second communication device 106. Each of the second communication devices 106A-N is further configured to transmit the detected list to the server 108.

The shopping store 100 may further include a number of image-capturing devices 110A-N located strategically in the shopping store 100, such that they can capture images of all the shelves or items. In an embodiment, the image capturing device 106 can be a camera or a surveillance camera. Each of the image-capturing devices 110A-N is configured to capture one or more images of the multiple items placed in the shelves. The image capturing device 110A-N may further include a means for sending the captured images to the server 108 for further processing.

In an embodiment, the server 108 may be an internal server located within the premises of the shopping store 100. In another embodiment, the server 108 may be located remotely and may connect and communicate with the second communication devices 106A-N, the image capturing devices 110A-N, and the first communication device 102 through a network (not shown) such as, but not limited to, the Internet. The server 108 is also configured to receive the detected list(s) from at least one of the second communication devices 106A-N. The server 108 is also configured to check whether at least one item of the received list is present in an aisle associated with the second communication device (e.g. 106) from which the list is received based on an identified location of the consumer 112. For example, if the consumer 112 is near aisle 5A then the second communication device associated with aisle 5A will send the list to the server 108. The server 108 is further configured to dynamically sort the one or more items of the received list based on the check performed. The items in the list closest to the person is sorted starting from the closest item to the farthest item. In other words the closest item the person is interested in “bubbles up” in the shopping list so that it is the first item on the list. The one or more items in the shopping list are dynamically sorted based on the identified location of the one or more items in the plurality of aisles with respect to the identified location of the consumer 112 in the shopping store 100. In an embodiment of the present disclosure, the closest item is highlighted and placed on the top in the sorted list. The server 108 is further configured to display the sorted list on the first communication device 102. The at least one item may be highlighted using a specific color and/or may be placed on top in the sorted list when the at least one item is present in the aisle which is closest to the consumer 112. The server 108 is further configured to identify a current location of the consumer 112 in the shopping store 100. The server 108 may also re-sort the one or more items of the sorted list dynamically based on a current location of the consumer 112 in the shopping store 100. The location of the consumer 112 may change in the shopping store 100 as the consumer 112 keeps on moving. The server 108 is configured to identify the location of the consumer 112 based on the location of the second communication device 106 from which the shopping list is received.

Further, the server 108 is configured to receive the captured images from the image capturing devices 110A-N and process them. In an embodiment, the server 108 may receive images at a predefined interval of time. For example, the server 108 may receive images at 6 AM daily, or 11 PM daily. Further, the server 108 may process the images and the received list to identify the one or more items, which are present in the aisle located near to current location of the consumer 112. Then, the server 108 may identify the images of the items present in the nearby aisle. The server 108 may further send the sorted list and the associated images of the one or more items to the first communication device 102. In an embodiment, the server 108 may also send extra information related to the items to the first communication device 102 for display. Then, the sorted list along with one or more links for images and/or extra information may be displayed at a display associated with the first communication device 102. In an embodiment, the first communication device 102 doesn't require a camera to receive and display images of the items. Thereafter, the consumer 112 may interact with the displayed list and image links accordingly.

In an embodiment, the server 108 is further configured to analyze the plurality of images and determine whether the plurality of shelves in the plurality of aisles require re-stocking based on the analysis. The server 108 is also configured to sort the identified one or more images based on the scanning of the plurality of images and augment the at least one item in the plurality of images in a colored box which identifies exact location of the at least one item in a shelf of the plurality of shelves.

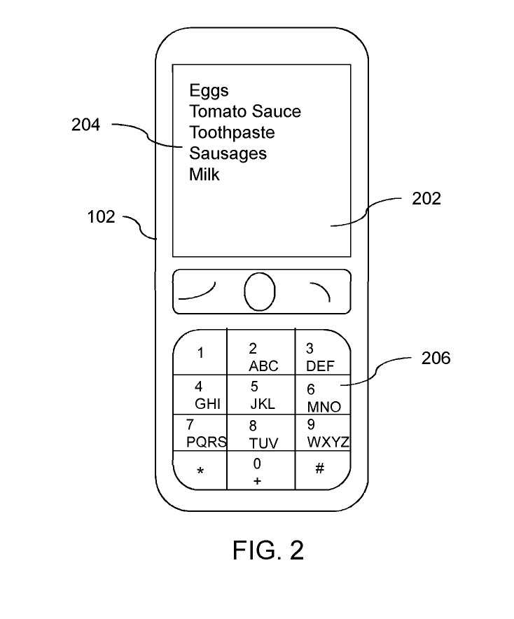

FIG. 2 illustrates an exemplary first communication device i.e. a smart phone including a shopping application, in accordance with an embodiment of the present disclosure. The smart phone 102 or the first communication device 102 may include a display screen 202 configured to display one or more characters entered by the consumer 112. As discussed with reference to FIG. 1, the consumer 112 may enter a shopping list 204 including one or more items. For example, the items may be such as, but not limited to, milk, tomato sauce, toothpaste, sausages, eggs, and so forth. The first communication device 102 further includes one or more buttons or keys 206 to enable the consumer 112 to enter the list of items on the first communication device 102. Though not shown, the first communication device 102 also includes the shopping application 104 configured to communicate with the second communication devices 106A-N, and the server 108. Further, the disclosed system for assisting the consumer to locate one or more items may be implemented without requiring camera in the first communication device 102. The first communication device 102 is configured to display one or more images received from the server 108. Also the first communication device 102 may not include a camera or any image capturing system.

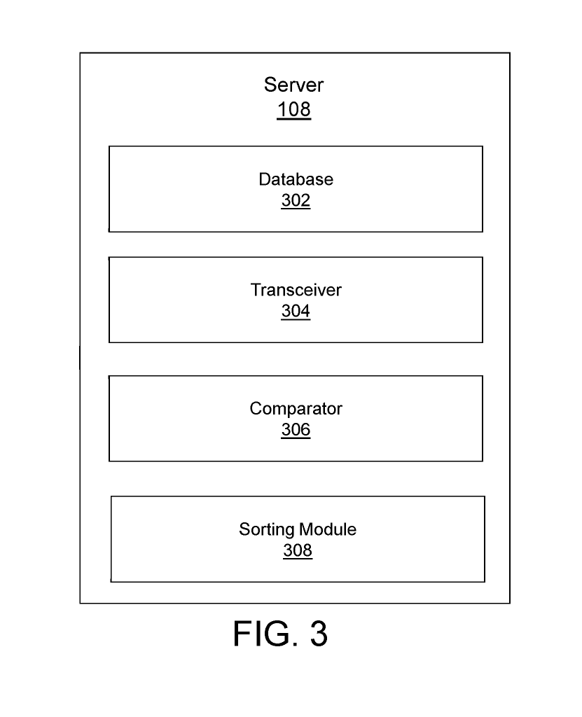

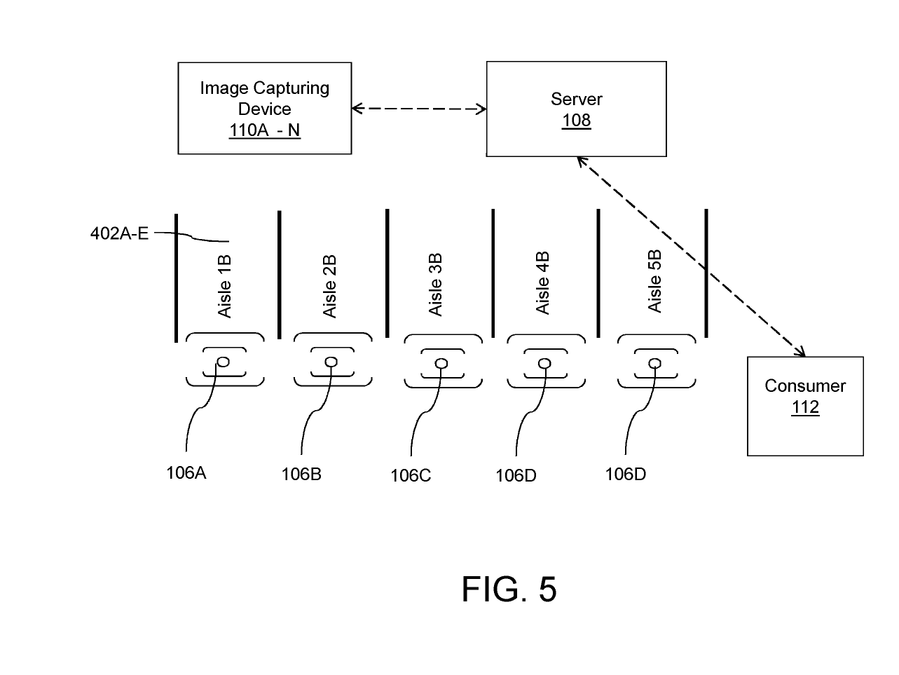

FIG. 3 illustrates exemplary structural components of the server 108, in accordance with an embodiment of the present disclosure. The server 108 may include a database 302 configured to store details about a number of items present in the shopping store 100. The details may include information such as, location of the items, substitute products of the items, expiry date of the items, and so forth. The items can be such as, but not limited to, grocery items, medical items, household items, depending on the type of the shopping store 100. In an embodiment of the present disclosure, the database 302 is configured to store one or more shopping lists associated with the one or more consumers (e.g. consumer 112). The server 108 is also configured to store one or more images of the items received from the one or more image capturing devices 110A-N at various intervals of time. The server 108 is also configured to store images of the substitute products of the items. The server 108 scans through the received list and sends a pictorial view of the shelf with a colored box locating where the item is (see FIG. 5).

In an exemplary scenario, everyday before opening of the shopping store 100, the image capturing devices 110A-N such as, cameras positioned at specific locations of the shopping store 100 (in this example existing surveillance cameras may be used to take pictures of store shelves, FIG. 1). Each picture is loaded into the database 302 and scanned for specific items that the shopping store 100 sells. The items may be identified through image identification/recognition similar to face recognition algorithms. In another embodiment, the items may be identified through one or more properties associated with the items such as, but not limited to, labels, shapes, colors, sized, and so forth.

In an embodiment, the image capturing devices 110A-N may take pictures at certain points of the day so that images are updated throughout the day. In an embodiment, the shopping store 100 may include an alarm that may be used to remind the image capturing devices 110A-N to take pictures or images again. Pictures taken after the morning snapshots can be compared to the pictures taken before the opening of the shopping store 100. Further, the database 302 may be updated with the latest pictures if images have changed.

Further, the images may help the staff (or people) of the shopping store 100 to maintain the inventory of items. Sometimes, the consumer may change the location of the one or more items. In such scenario, the staff may identify from the images one or more items, which have been misplaced by the consumer(s) 112.

Further, the server 108 includes a transceiver 304 configured to receive one or more shopping lists and other information such as unique ID of the second communication devices 106A-N from the one or more second communication devices 106A-N. The transceiver 304 is also configured to transmit or send sorted lists, image links and/or images to the first communication device(s) 102 for display. The transceiver 304 is further configured to receive the one or more images from the image capturing devices 110A-N at different predefined intervals of time. In an embodiment, the transceiver 304 is also configured to send one or more information about the items to the first communication device 102.

The server 108 also includes a comparator 306 configured to compare received list with information of a variety of items present in the database. Based on this comparison, the comparator 306 identifies the one or more items of the list, which are present in the aisle near to the consumer 112. The comparator 306 is also configured to scan the stored images and identify the images of one or more items of the shopping list (e.g. 204), which are present in the aisle. Further, the comparator 306 may highlight or augment the one or more items shown in the image, which is present in the shopping list using a particular color. For example, if shopping list includes green bell pepper, then the comparator 306 looks for the image including green bell pepper and augments the capsicum using a color such as red, blue etc. to highlight the green bell pepper in the image. In an embodiment, the other objects nearby the items present in the shopping list may also be highlighted based on one or more criteria. The criteria can be such as nutritional value, calorie count of the item, expiry date of the item, price of the item, and so forth. For example, in the image including green bell pepper, the comparator 306 may augment yellow pepper and red pepper also which may be located adjacent to the green bell pepper in the image. This way the consumer 112 may be provided with more options, variety, or substitute(s) of the item of the shopping list. The consumer 112 then may take a more informed decision about selecting the item.

The server 108 also includes a sorting location identifier 308 configured to identify location of the consumer(s) 110, the first communication device 102, and the second communication devices 106A-N. In an embodiment, the location identifier 308 identifies the location of the first device 102 based on a unique ID associated with the second communication device 106 from which the shopping list is received. The server 108 also includes a sorting module 310 configured to sort one or more items of the shopping list based on the comparison done by the comparator 306. The sorting module 310 is further configured to dynamically sort or re-sort the one or more items of the shopping list based on the comparison performed and current location of the consumer 112. The transceiver 304 then may send the sorted list and links of the identified images to the first communication device 102.

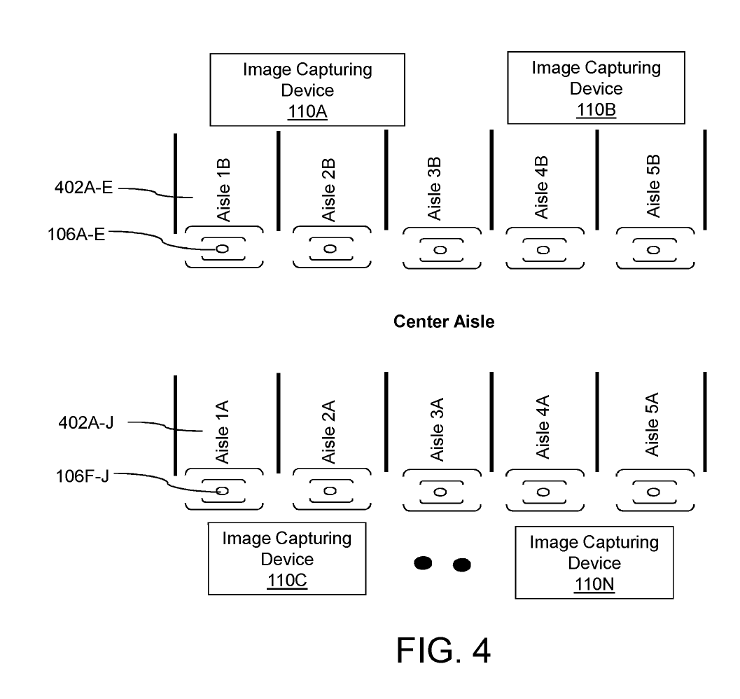

FIG. 4 is an exemplary environment 400 illustrating the location of the one or more second communication devices 106A-N and the one or more image capturing devices 110A-N, in accordance with an embodiment of the present disclosure. As shown, the environment 400 may include one or more aisles 402A-G, each of these aisles 402A-G have an associated unique identification (e.g. 1A-5A and 1B-5B). A person skilled in the art will appreciate that the environment 400 may include more aisles 402 than shown. Each of the aisles 402 may include a number of items or products placed in one or more shelves (not shown). At least one second communication device 106 is placed strategically near each of the aisles 402. When the first communication device 102 is within a predefined range of distance of the second communication device 106 then the second communication device 106 may detect a shopping list (e.g. 204) on the first communication device 102. The predefined range of distance may define a distance in which the second communication device 106 may detect another communication device such as, the first communication device 102. The second communication device 106 may have the predefined range of 2 meters, 1 meter, 3 meters, and so forth. Further, each of the second communication devices 106A-N is configured to establish a two-way communication with the shopping application 104 running on the first communication device 102. The communication distance is such that only one of the second communication devices 106A-N, which is nearest to the consumer 112 is able to connect with the first communication device. So, if the person is near or at Aisle 5A, only the second communication device 106J present on the Aisle 5A is able to “talk” or communicate with the first communication device 102. In essence the server 108 knows that the communication is coming from Aisle 5A.

As shown, one or more image capturing devices 110A-N may be strategically located in the shopping store 100 (or environment 400). Each of the image capturing devices 110A-N may capture images of a predefined area of the shopping store 100. For example, the image capturing device 110A may capture images of the Aisle 1B, Aisle 2B, and Aisle 3B and send them to the server 108 accordingly. The image capturing devices 110A-N may also include an inbuilt alarm such as a software alarm, which may remind the image capturing devices 110A-N to click or capture images after a predefined time interval. The image capturing devices 110A-N may be surveillance cameras used in the shopping store 100.

FIG. 5 illustrates communication between one or more devices in the shopping store 100, in accordance with an embodiment of the present disclosure. As discussed with reference to FIGS. 1-4, the consumer 112 may input a shopping list including one or more items using the shopping application 104 on the first communication device 102. The consumer 112 may enter the shopping store 100 by carrying the first communication device 102. As soon the consumer 112 (or the first communication device 102) comes in a range of one of the second communication devices 106A-N, a second communication device such as 106E may detect the shopping list. Then, the second communication device 106E may send the detected list to the server 108, which may be located inside or outside of the premises of the shopping store 100. The shopping list received from the first communication device 102 is sent to the server 108 by the second communication device 106, where the list is processed and then responded to. The response message is received by the first communication device 102 and then acted on. The server 108 may process and sort out the received list according to where the consumer 112 is currently located in the shopping store 100.In an exemplary scenario, after receiving information from Aisle 5A together with the shopping list of items from the shopping application 104, the server 108 can process the list and figure out if there is an item on that specific Aisle 5A that is on the shopping list and sort the shopping list accordingly.

The server 108 is also configured to receive the one or more captured images from the image capturing devices 110A-N located at multiple locations in the shopping store 100. The server 108 may also identify one or more images including the one or more items of the received list. The server 108 may receive, analyze and process the shopping list. The server 108 may check whether at least one item of the received shopping list is present in the Aisle 5B, which is associated with the second communication device 106E based on an identified location of the consumer 112. Thereafter, the server 108 dynamically sorts the one or more items of the shopping list based on the check performed. If for example an item on the list is milk, and milk is in Aisle 5A, then the list sent back to the first communication device sorts out milk to be on top of the list. The server 108 may also scan through the one or more stored images to identify an image including one or more items of the list. Then, the server 108 may augment the one or more items in the selected images using a particular color such as, but not limited to, red, yellow, green, white, and so forth. Though not shown, but a person skilled in the art will appreciate that the shopping store 100 may have more than one associated server 108.

Then, the server 108 may send and display the sorted list along with the image links on the display 202 associated with the first communication device 102. Further, in the sorted list the at least one item is highlighted and/or placed on the top in the sorted list when the at least one item is present in the Aisle 5B, which is closest to the consumer. Also, a number of image links corresponding to the one or more items are displayed at the first communication device 102. The consumer 112 may click or select an image link of the image links to see a picture or image of the item corresponding to which the image link is displayed. Thereafter, the consumer 112 may pick the at least one item from the location identified through the displayed sorted list and the image.

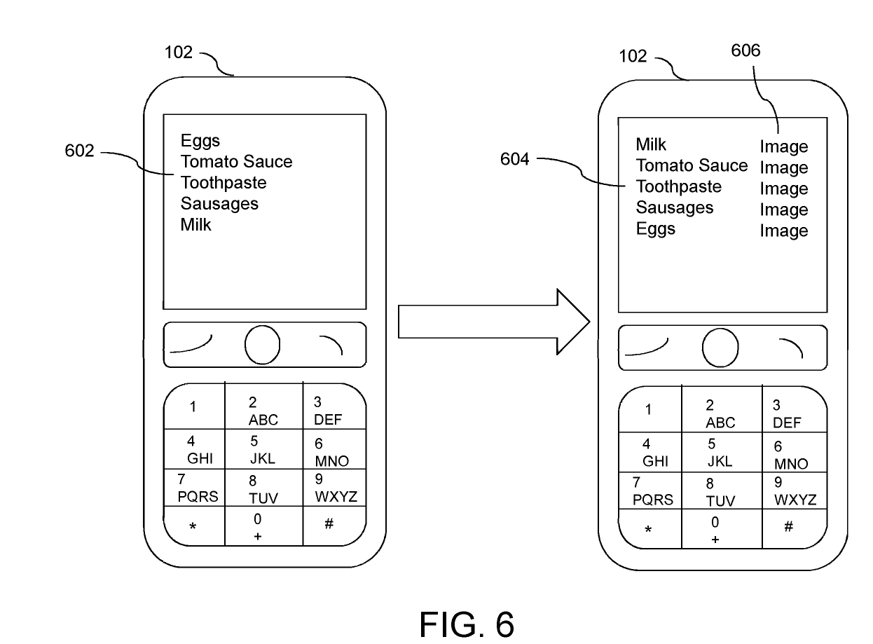

FIG. 6 depicts before and after display of one or more items on the first communication device 102 after the communication between the server 108 and the shopping application 104 happens, in accordance with an embodiment of the present disclosure. The shopping list before dynamic sorting is shown as display 602 and shopping list after dynamic sorting is shown as display 604. The display 604 also includes one or more image links 606 corresponding to the one or more items. The display 604 may also include further information regarding each of the items in the sorted list. The information may include such as, but not limited to, expiry date, etc. of the item. The sorted list includes the item, which is closest to the consumer 112 at the top.

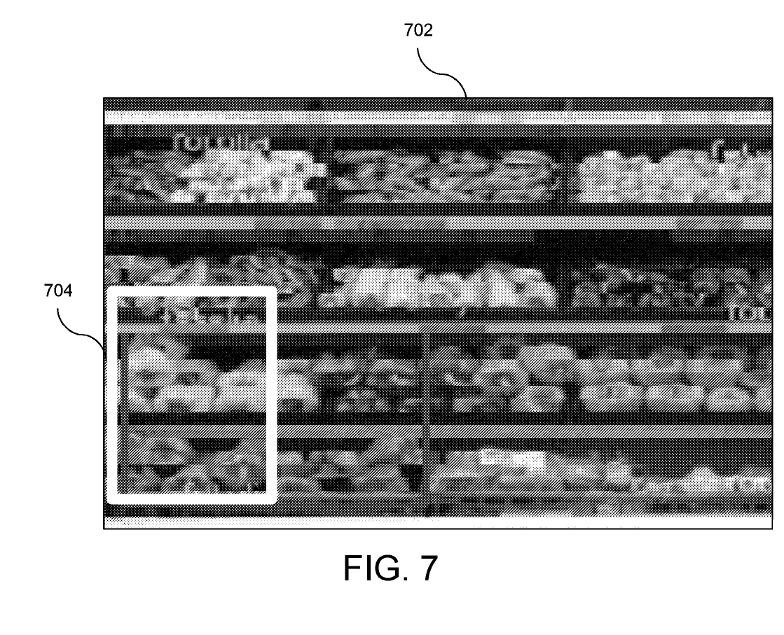

As shown, the at least one item i.e. milk in this example, is placed on the top when the milk is located in an aisle near to the consumer 112. The at least one item may also be highlighted using a color, such as red, blue, green, and so forth (as shown in FIG. 7). The consumer 112 may click on one of the image link 606. Based on the click or selection received from the consumer 112, an image including the augmented item is displayed on the display of the first communication device 102. In an embodiment, more than one item is highlighted in the image. The server 108 may also push out additional information to help the consumer 112 to make an informed decision. For example, if an item placed adjacent to the highlighted item is on Sale, have fewer calories or are fat free, then the server 108 may augment that item also.

Further, as the consumer 112 moves in the shopping store 100, the shopping list may get resorted and display 604 on the first communication device 102 may change. Similarly, arrangement of the image links 606 may also change based on the current location of the consumer 112 in the shopping store 100. In an embodiment, the shopping application 104 allows the consumer 112 to disable or delete an item and its associated image link from the display 604. For example, after picking the item from a shelf in the aisle the consumer 112 may touch the highlighted item or associated image link to disable or delete it. In an embodiment, the highlighted item goes at the bottom or is removed from the sorted list after receiving the selection information from the consumer 112, i.e. when the consumer 112 has touched the at least one item or associated image link.

FIG. 7 is an exemplary image 702, in accordance with an embodiment of the present disclosure. As discussed with reference to FIGS. 1-6, the server 108 may receive one or more images from the image capturing devices 110A-N and may process them. The image 702 is a processed image displayed at the first communication device 102. The image 702 also includes an augmented area 704. The item in the augmented area 704 includes an item of the shopping list, which is near to the consumer 112. The item in the image 702 may be augmented using any suitable color to help the consumer 112 identify the location of the item. Further, in an embodiment, the augmented area 704 may includes one or more items.

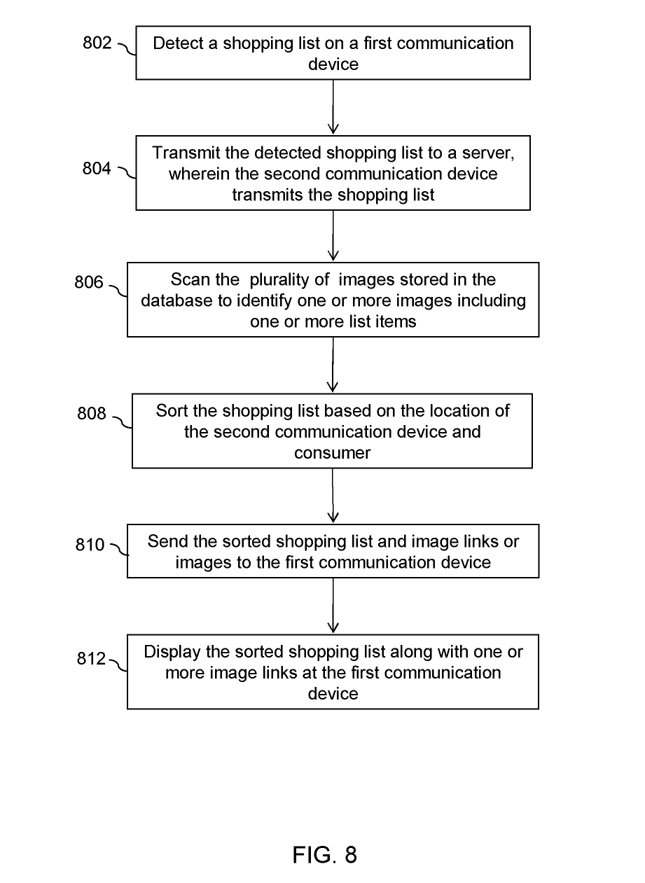

FIG. 8 illustrates a flowchart diagram illustrating a method for intelligently locating one or more items in a shopping store, in accordance with an embodiment of the present disclosure. As discussed with reference to FIGS. 1-7, the shopping store 100 includes a number of second communication devices 106A-N placed strategically near each aisle 402A-E in the store. The shopping store 100 also includes a one or more image capturing devices 110A-N such as cameras located near one or more aisles. Further, the shopping store 100 has an associated server 108 which may or may not be present inside the shopping store. Though not shown, but a person skilled in the art will appreciate that the shopping store 100 may have more than one associated server 108. The second communication devices 106A-N may communicate with the server 108 and the first communication device 102.

At step 802, at least one of the second communication devices 106A-N detects a shopping list including one or more items or product details on the first communication device 102. The consumer 112 enters the shopping list on the first communication device 102 using the shopping application 104 running at the first communication device 102. At step 804, the detected shopping list may be transmitted to the server 108 by the at least one of the second communication devices 106A-N such as 106A. Then at step 806, the server 108 may scan a number of images stored in the database 302 to identify one or more images including one or more items of the shopping list. The server 108 also augments the identified items of the list in the image. At step 808, the server 108 may analyze and dynamically sort the shopping list based on an identified location of the consumer 112 and the aisle associated with the second communication device 106A. In an embodiment, the sorting module 308 sorts the received shopping list. At step 810, the server 108 may send the sorted list and the image links or images to the first communication device 102. Thereafter, at step 812, the sorted list along with one or more image links or images is displayed on the first communication device 102. In an embodiment of the present disclosure, the server 108 may display the sorted list on a display associated with the first communication device 102. In another embodiment, the shopping application 104 running on the first communication device 102 may display the sorted list at the first communication device 102.

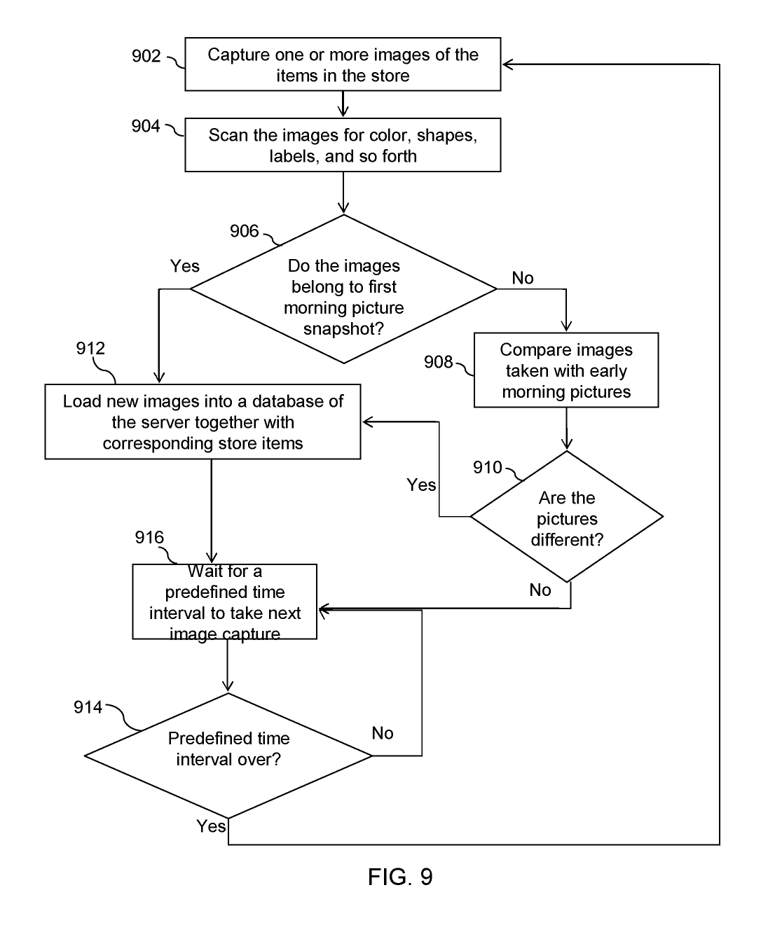

FIG. 9 illustrates a flowchart diagram illustrating a method for updating a database with a plurality of images by one or more image capturing devices, in accordance with an embodiment of the present disclosure. At step 902, one or more image capturing devices 110A-N may capture a number of images of various items placed in different shelves in multiple aisles 402A-J in the store. At step 904, the captured images may be scanned for color, shape, label, and so forth associated with the items. At step 906, it is checked whether the images belong to first morning picture snapshot. If the images belong to first morning picture snapshot then step 912 is followed else step 908 is followed. At step 908, the captured images are compared with a number of images that were taken or captured in the morning. Then, at step 910, it is checked whether the recently captured images are different than the plurality of images captured in the morning. If the images are different then step 912 is followed else control goes to step 916.

At step 912, the recently captured images or the new images are loaded into the server's database 302 together with the store's items. In an embodiment, additional information about the store's items may also be loaded in the database 302. Then, at step 914, it is checked whether a predefined time interval is over. If the predefined time interval is over, then the process control goes to step 902 and new images are captured. If the predefined time interval is not over then, step 916 if followed. At step 916, the image capturing devices 110A-N waits for a predefined time interval to get over and to take new picture after the predefined time interval is over.

An advantage of the disclosed system and method is that images of store inventory and their shelf locations are updated everyday (before the store opens). This allows the server(s) 108 to correctly send the latest information location of each item from the shopping store shelves. This avoids having “stale” or old images from the shopping store 100.

The present disclosure also provides a system, which avoids having to use the person's mobile device camera to feed information back to the server(s)108 (in the case of augmented reality). In addition, holding the camera to certain shelf location while shopping is not convenient for the person shopping or other shoppers in the vicinity.

Another advantage of the disclosed system and methods is providing information to the staff of the shopping store 100 regarding inventory of the items. As staff people may analyze store shelf visuals and may use them to see if store shelves need restocking of inventory or comparing the empty shelves of where a stock of an item should be compared to their store inventory in the database 302. Further, the images gathered may serve as another data point when deciding to reorder certain items out of stock. Images showing empty or near empty shelves can be flagged for re-stocking This saves time for manual visual inspections of store attendants. Also when empty shelves are identified items in those shelves are compared to what is in inventory to verify if there is a need to re-order the same items.

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions may be loaded onto one or more general-purpose computers, special purpose computers, or other programmable data processing translator to produce machines, such that the instructions, which execute on the computers or other programmable data processing translator create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims. The invention has been described in the general context of computing devices, phone and computer-executable instructions, such as program modules, being executed by a computer. Generally, program modules include routines, programs, characters, components, data structures, etc., that perform particular tasks or implement particular abstract data types. A person skilled in the art will appreciate that the invention may be practiced with other computer system configurations, including hand-held devices, multiprocessor systems, microprocessor-based or programmable consumer electronics, network PCs, minicomputers, mainframe computers, and the like. Further, the invention may also be practiced in distributed computing worlds where tasks are performed by remote processing devices that are linked through a communications network. In a distributed computing world, program modules may be located in both local and remote memory storage devices.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the various embodiments of the present invention has been presented for purposes of illustration, but is not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for managing inventory comprising a plurality of items of a shopping store, wherein the shopping store comprises the plurality of items arranged in a plurality of aisles, the method comprising:
detecting, by a second communication device associated with an aisle, a shopping list comprising one or more items on a first communication device, wherein a consumer inputs the list on the first communication device;
transmitting, by the second communication device, the detected list to a server associated with the shopping store;
transmitting, by a plurality of image capturing devices, a plurality of images to the server, wherein the plurality of images are transmitted at a predefined time interval;
checking, by the server, whether at least one item of the received list is present in an aisle associated with the at least one second communication device from which the shopping list is received based on an identified location of the consumer;
scanning, by the server, the plurality of images to identify one or more images including the at least one item;
dynamically sorting, by the server, the one or more items in the received list based on the checking performed;
displaying the dynamically sorted list along with one or more image links on the first communication device, wherein the at least one item in the sorted list is at least one of highlighted or placed on top based on the check performed, further wherein each of the image links comprises an image with at least one augmented item; and
determining, by the server, whether one or more items need to be restocked in a plurality of shelves in the shopping store to maintain the inventory of the plurality of items based on the plurality of images.

2. The method of claim 1, wherein the first communication device comprises a smart phone having a shopping application configured to:
communicate with the plurality of second communication devices, the plurality of image capturing devices, and the server; and
receive one or more images from the server.

3. The method of claim 1, wherein the server comprises a database configured to maintain details about the plurality of items present in the shopping store and the plurality of images.

4. The method of claim 3, wherein the plurality of image capturing devices are configured to transmit the plurality of images and update the database at beginning of day, and before opening of the shopping store.

5. The method of claim 1 further comprising allowing the consumer to input a plurality of shopping lists associated with a plurality of shopping stores on the first communication device.

6. The method of claim 1 further comprising:
identifying, by the server, a current location of the consumer based on the shopping list received from the second communication device, wherein each of the second communication devices is assigned a unique identity (ID); and
re-sorting, by the server, the one or more items of the sorted list dynamically based on the current location of the consumer in the shopping store, wherein the consumer is moving in the shopping store.

7. The method of claim 6, wherein the one or more items in the shopping list are dynamically sorted and re-sorted based on location of the one or more items in the plurality of aisles with respect to an identified location of the consumer in the shopping store, further wherein the closest item is highlighted and placed on the top in the displayed list along with an image link.

8. The method of claim 7 further comprising:
sorting, by the server, the identified one or more images based on the scanning of the plurality of images; and
augmenting, by the server, the at least one item in the plurality of images in a colored box which identifies exact location of the at least one item in a shelf of the plurality of shelves.

9. The method of claim 8 further comprising:
analysing, by the server, the plurality of images; and
determining, by the server, whether the plurality of shelves in the plurality of aisles require re-stocking based on the analysis.

10. The method of claim 9 further comprising allowing the consumer to disable the at least one highlighted item by selecting the at least one highlighted item after picking the item from it's respective location in the shelf.

11. The method of claim 1, wherein the server is located in the premises of the shopping store.

12. The method of claim 1, wherein the server is located at a remote location outside the premises of the shopping store.
